(19) United States
(12) Patent Application Publication
(10) Pub. No.: US 2026/0288454 A1
(43) Pub. Date: Sep. 24, 2026

(54) METHOD, APPARATUS, DEVICE AND STORAGE MEDIUM FOR MANAGING APPLICATION

(71) Applicants: Beijing Zitiao Network Technology Co., Ltd., Beijing (CN); Lemon Inc., Grand Cayman (KY)

(72) Inventors: Lei Wang, Beijing (CN); Yi Zhao, Beijing (CN); Yulin Deng, Beijing (CN); Jun Ge, Beijing (CN); Yi Zhang, Los Angeles, CA (US); Huibin Su, Beijing (CN)

(21) Appl. No.: 19/476,155

(22) PCT Filed: May 20, 2024
(86) PCT No.: PCT/CN2024/094315

§ 371 Date: Oct. 16, 2025

(30) Foreign Application Priority Data
May 24, 2023 (CN) 202310596011.X

(51) Int. Cl. G06F 8/70; G06F 8/36; H04L 51/02

(52) U.S. Cl. CPC G06F 8/70; G06F 8/36; H04L 51/02

(57) ABSTRACT

According to the disclosure, a method, apparatus, device and a storage medium for managing an application are provided. An example method includes: receiving a first chat message from a user, the first chat message indicating creation or modification of a target application; determining, based on at least interaction information between the user and a digital assistant in a chat window, a predetermined operation for at least one functional block of the target application; and performing, in response to a reception of a confirmation of the user for the predetermined operation in the chat window, the predetermined operation on the at least one functional block. and

This application claims priority to Chinese Patent Application No. 202310596011.X, filed on May 24, 2023, entitled “METHOD, APPARATUS, DEVICE AND STORAGE MEDIUM FOR MANAGING APPLICATION”, the entire content of which is incorporated herein by reference.

### FIELD

Example embodiments of the present disclosure generally relate to the field of computers, and in particular, to a method, apparatus, device and computer-readable storage media for managing an application.

### BACKGROUND

With the development of computer technologies, more and more applications provide services for people in various aspects of work and life. Different types of applications are used to implement different functions, or different users may have different requirements on the functions of the same type of application. In this case, the user may desire to build and maintain his/her own application. Therefore, how to help the user to manage the application is important.

### SUMMARY

In a first aspect of the present disclosure, a method for managing an application is provided. The method includes: receiving a first chat message from a user, the first chat message indicating creation or modification of a target application; determining, based on at least interaction information between the user and a digital assistant in a chat window, a predetermined operation for at least one functional block of the target application; and performing, in response to a reception of a confirmation of the user for the predetermined operation in the chat window, the predetermined operation on the at least one functional block.

In a second aspect of the present disclosure, a method for managing an application is provided. The method includes: presenting a first interface associated with one of a first mode and a second mode for application management; and presenting a second interface associated with the other of the first mode and the second mode in response to a mode switch indication, and wherein in the first mode, an application management operation is performed by an interaction between a user and a digital assistant in a chat window without an application editing interface, and in the second mode, an application management operation is performed by a user interaction in an application editing interface.

In a third aspect of the present disclosure, a method for managing an application is provided. The method includes: presenting a first editing interface of a target application; receiving, in the first editing interface, an adjustment request for the target application; and adjusting at least a portion of the target application based on a user interaction context associated with the adjustment request.

In a fourth aspect of the present disclosure, an apparatus for managing an application is provided. The apparatus includes: a first receiving module, configured to receive a first chat message from a user, the first chat message indicating creation or modification of a target application; a determining module configured to determine, based on at least interaction information between the user and a digital assistant in a chat window, a predetermined operation for at least one functional block of the target application; and a performing module configured to perform, in response to a reception of a confirmation of the user for the predetermined operation in the chat window, the predetermined operation on the at least one functional block.

In a fifth aspect of the present disclosure, an apparatus for managing an application is provided. The apparatus includes: a first presentation module, configured to present a first interface associated with one of a first mode and a second mode for application management; and a second presentation module, configured to present a second interface associated with the other of the first mode and the second mode in response to a mode switch indication, and wherein in the first mode, an application management operation is performed by an interaction between a user and a digital assistant in a chat window without an application editing interface, and in the second mode, an application management operation is performed by a user interaction in an application editing interface.

In a sixth aspect of the present disclosure, an apparatus for managing an application is provided. The apparatus includes: third presentaton module, configured to present a first editing interface of a target application; a second receiving module, configured to receive, in the first editing interface, an adjustment request for the target application; and an adjustment module, configured to adjust at least a portion of the target application based on a user interaction context associated with the adjustment request.

In a seventh aspect of the present disclosure, an electronic device is provided. The device includes: at least one processing unit; and at least one memory coupled to the at least one processing unit and storing instructions for execution by the at least one processing unit. The instructions, when executed by the at least one processing unit, cause the device to perform the method of the first aspect or the second aspect or the third aspect.

In an eighth aspect of the present disclosure, a computer-readable storage medium is provided. The computer-readable storage medium stores thereon a computer program executable by a processor to implement the method of the first aspect or the second aspect or the third aspect.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments of the present disclosure can be implemented;

FIG. 2 illustrates a schematic diagram of an example of receiving an input information interface according to some embodiments of the present disclosure;

FIG. 3A to FIG. 3D respectively illustrate schematic diagrams of example chat windows according to some embodiments of the present disclosure;

FIG. 4A to FIG. 4C respectively illustrate schematic diagrams of an example editing interface according to some embodiments of the present disclosure;

FIG. 5 illustrates a flowchart of a process for managing an application according to some embodiments of the present disclosure;

FIG. 6 illustrates a flowchart of a process for managing an application according to some other embodiments of the present disclosure;

FIG. 7 illustrates a flowchart of a process for managing an application according to still other embodiments of the present disclosure;

FIG. 8 illustrates a block diagram of an apparatus for managing an application according to some embodiments of the present disclosure;

FIG. 9 illustrates a block diagram of an apparatus for managing an application according to some other embodiments of the present disclosure;

FIG. 10 illustrates a block diagram of an apparatus for managing an application according to still other embodiments of the present disclosure; and

FIG. 11 illustrates a block diagram of a device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for illustrative purposes only and are not intended to limit the scope of the present disclosure.

In the description of the embodiments of the present disclosure, the terms “include” and its variants should be understood as open terms that mean “include, but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below.

Herein, unless explicitly stated, one step is performed “in response to A” does not imply that this step is performed immediately after “A”, but may include one or more intermediate steps.

It may be understood that the data involved in the technical solution (including but not limited to the data itself, the obtaining, using, storing or deleting of the data) should follow the requirements of the corresponding laws and regulations and related regulations.

It can be understood that before using the technical solutions disclosed in the embodiments of the present disclosure, relevant users should be informed of the types, use ranges, usage scenarios, and the like of the information related to the present disclosure in an appropriate manner according to relevant laws and regulations, and the authorization of the related users may be obtained, wherein the relevant users may include any type of rights body, such as individuals, businesses, and groups.

For example, in response to receiving an active request of a user, prompt information is sent to the related user to explicitly prompt the related user that the operation requested to be performed will need to obtain and use the information of the related user, so that the related user can autonomously select whether to provide information to software or hardware such as electronic device, application program, server or storage medium executing the operation of the technical solution of the present disclosure according to the prompt information.

As an optional but non-limiting implementation, in response to receiving an active request of a related user, a manner of sending prompt information to the related user may be, for example, a pop-up window, and prompt information may be presented in text in the pop-up window. In addition, the pop-up window may further carry a selection control for the user to select “agree” or “disagree” to provide information to the electronic device.

It may be understood that the foregoing notification and obtaining a user authorization process are merely illustrative, and do not constitute a limitation on implementations of the present disclosure, and other manners of meeting related laws and regulations may also be applied to implementations of the present disclosure.

Further as used herein, the term “machine learning model” may learn associations between respective inputs and outputs from training data, such that corresponding outputs may be generated for a given input after training is completed. The generation of the machine learning model may be based on machine learning techniques. Deep learning is a machine learning algorithm that processes inputs and provides corresponding outputs by using a multi-layer processing unit.

As briefly mentioned above, applications may provide various services for people. Management of applications (e.g., development, creation of new applications, or modification, editing of existing applications) is typically developed by developers of applications based on the desired function provided by the application. For example, in the case where the application is expected to provide the function of purchasing goods, the developer may write code for implementing the goods purchase function. Accordingly, these codes may be encapsulated for application. However, under the influence of factors such as different programming languages and code logic understanding differences, there are problems such as high code writing difficulty and large workload. This puts a high requirement on the development capabilities of developers for application management.

In this regard, one conventional approach is to encapsulate code for implementing various functions into functional blocks. In the development of applications, functional blocks may be selected based on the required functions and combined into applications. Therefore, the difficulty and workload of application development and maintenance can be reduced to a certain extent. However, in such a conventional solution, the development capability of the developer is still high. For example, a developer is still required to determine functional blocks required by an application, and understand differences between different functional blocks, combinatorial logic between functional blocks, and so forth. Otherwise, it is difficult to implement the combination of functional blocks and to modify the functional blocks that have completed the combination.

To this end, embodiments of the present disclosure provide a method for managing an application. According to various embodiments of the present disclosure, a user may provide a chat message indicating creation or modification of a target application. Then, the user may perform at least one round of interaction with the digital assistant in the chat window. The interaction information may be used to determine a predetermined operation for at least one functional block of the target application. If confirmation is received in the chat window for the predetermined operation from the user, a predetermined operation is performed on the at least one functional block.

Thus, a user may complete management of an application, such as creation and/or modification of an application, through a chat (e.g., a natural language chat). Not only can the management difficulty of the application be reduced, but also the application closer to the user demand can be provided, and the management experience of the user to the application is improved. In addition, this application management solution greatly reduces the requirements for development capability. Not only can developers as professionals create and modify applications, but ordinary users can also create and modify applications.

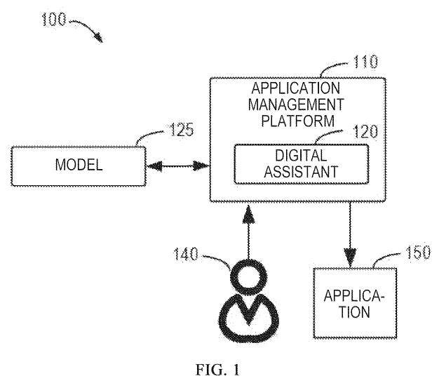

FIG. 1 illustrates a schematic diagram of an example environment 100 in which embodiments of the present disclosure can be implemented. In environment 100, application management platform 110 may be used by user 140 who wishes to manage application to manage application 150. For example, the functional blocks provided by the application management platform 110 may be combined to create the application 150. As another example, a portion of the created application 150 may be modified, e.g., to modify a certain functional block. In some embodiments, the application management platform 110 may also be considered an application that provides application management services.

The application management platform 110 is configured with a digital assistant 120 that may interact with the user 140 to obtain information from and/or provide information to the user 140. For example, the application management platform 110 may provide the user 140 with a chat window for interacting with the digital assistant 120. Correspondingly, the user 140 may interact with the digital assistant in the chat window, for example, input a chat message, receive feedback content of the digital assistant for the chat message, and the like.

In embodiments of the present disclosure, the digital assistant 120 is used for chat with the user 140. An interaction window, such as a chat window, between the user 140 and the digital assistant 120 is presented in the client interface. The digital assistant 120, as an intelligent assistant, has an intelligent chat and information processing capability. In the chat window, the user inputs a chat message in the chat window, and the digital assistant provides a reply message in response to the chat message. The client interface for presenting the chat window may correspond to the application management platform 110 or a multifunction collaboration platform capable of implementing application management.

The digital assistant 120 may be invoked or awakened in an appropriate manner (e.g., shortcut, button, or voice) to present a chat window with the user 140. For example, the digital assistant 120 may be woken up or invoked in response to an application management request by the user 140. The chat window may include interface elements for information interaction, such as input boxes, message lists, message bubbles, and the like.

In some embodiments, application management platform 110 may utilize model 125 to provide application management function to user 140. In some embodiments, the model 125 may be a machine learning model, a deep learning model, a learning model, a neural network, or the like. In some embodiments, the model 125 may be based on a language model (LM). The model 125 may also be based on other suitable models.

The model 125 may be deployed on or accessible by the application management platform 110. Alternatively, application management platform 110 may communicate with model 125 to provide application management services for user 140 using model 125. For example, the application management platform 110 may send a prompt input to the model 125 based on the interaction information between the user 140 and the digital assistant 120, and obtain a processing result of the model 125. Alternatively or additionally, the digital assistant 120 itself may also be derived based on the model 125. For example, such a digital assistant 120 may be derived based on a natural language processing model. The digital assistant 120 may process the chat message input by the user 140 to obtain a requirement of the user 140, for example, an application desired to be created by the user 140, a function desired to be implemented by the application, and the like. The model 125 may be configured locally or independently of the application management platform 110 according to requirements, and the present disclosure is not intended to be limited thereto.

In some embodiments, the application management platform 110 may be an application platform-as-a-service (aPaaS) based platform. APaaS is a cloud service that provides an environment for the development and operation of software applications. APaaS allows developers to create large scale applications. Therefore, by using the digital assistant 120, the aPaaS based platform can further reduce the requirement on the development capability of the user 140, can assist the user 140 more widely to manage the target application, and improve the user experience.

In the environment 100, the application management platform 110 may be deployed in an electronic device, and the electronic device may be any type of device having computing capability, including a terminal device or a server device. The terminal device may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an e-book device, a gaming device, or any combination of the foregoing, including accessories and peripherals of these devices, or any combination thereof. The server device may include, for example, a computing system/server, such as a mainframe, an edge computing node, a computing device in a cloud environment, or the like.

It should be understood that the structure and function of the environment 100 is described for illustrative purposes only and does not imply any limitation to the scope of the present disclosure.

Some example embodiments of the present disclosure will be described below with continued reference to the accompanying drawings.

As a trigger for application management, the application management platform 110 receives a chat message, also referred to as a first chat message, from the user 140. The first chat message indicates the creation or modification of the target application. The first chat message may also be referred to as an application management request. In some embodiments, the first chat message indicates to create a new application. In some embodiments, the first chat message indicates to modify the created application 150 (which is referred to as a target application for ease of understanding). Although represented as a “first chat message,” it is understood that the first chat message indicating the creation or modification of the target application may be a plurality of inputs from the user. In some embodiments, the user input may include input in a multimodal form, such as text input (e.g., input in natural language form), voice input, image input, video input, and so forth. For example, a user may provide chat messages through natural language (e.g., text and voice), body language (e.g., gestures). As another example, various media content, such as images, audio, video, links, etc., may be included in the chat message. The application management platform 110 may parse these multimodal chat messages. In the following, description is made in natural language as an example, but this is merely illustrative and not intended to be limiting. Embodiments described with respect to natural language apply equally to interactions of other modalities.

For example, where the user 140 desires to create a target application (e.g., an XX application), the user 140 may provide a message, represented in natural language, to the application management platform 110 in the form of, for example, text, voice, or the like, to instruct the application management platform 110 to create the target application. For example, the first chat message may be “Help me build an XX system”. Similarly, where the user 140 desires to modify the XX application, the user 140 may provide a first chat message, such as “Help me modify an existing XX system,” to instruct the application management platform 110 to modify the created application.

In some embodiments, the application management platform 110 may present an input box to the user 140 and information prompting the user 140 to create or modify the application. The input box may receive a user input, such as a natural language text input or a natural language voice input of the user. In this way, the user 140 may be facilitated to propose his/her needs based on the information and quickly indicate the needs with the input box. Further, the application management platform 110 may obtain a chat message of the user 140 by using an input box, to implement interaction with the user 140.

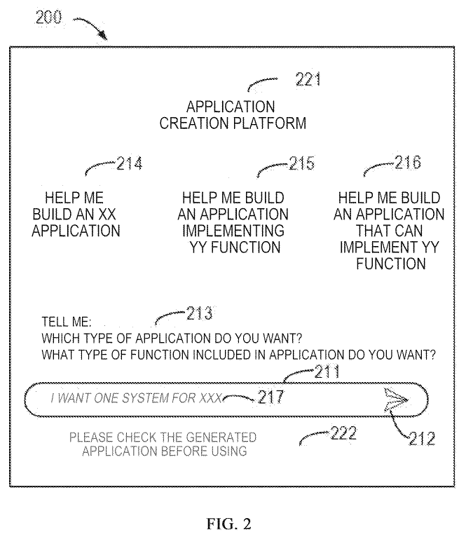

For example, reference may be made to FIG. 2. In the example of FIG. 2, application management platform 110 may provide interface 200. In the interface 200, an input box 211 is presented for the user 140 to provide natural language text input or other types of input. After entering the text in the input box 211, the user 140 may trigger the control 212 (for example, click the control 212) to send the text. The interface 200 also presents prompt information 213-216 to prompt the user 140 how to describe the application expected to create in different expression forms. For example, the prompt information 214 may prompt the user 140 to enter text in the form of informing the name of the application desired to be created (e.g., “Help me build an XX application”). Alternatively or additionally, prompt information 217 may also be presented in the input box 211 to prompt the user 140 in a more directly and intuitively way. For example, the prompt information 217 may be presented in the input box 211 in a floating manner, and the prompt information 217 is hidden when it is detected that the user 140 has entered content in the input box 211.

In some embodiments, the application management platform 110 may not be able to determine the target application that the user 140 expects to create or modify based on their initial input. For example, the expression of the input is fuzzy or broad, so that the application management platform 110 cannot accurately determine the specific requirement for the target application. For example, the initial input provided by the user 140 is “create a social application”, in which case the application management platform 110 cannot accurately understand the specific requirements of the user for the “social application”. In this regard, the application management platform 110 may further provide the query information to the user 140 to determine the target application that the user 140 desires to create or modify by further interaction. For example, for “create a social application,” the application management platform 110 may feed back “which type of social application do you desire to create? content sharing type? or instant interaction Type?” to the user 140, and so on. Accordingly, the user's needs may be refined based on such multi-round interactions to accurately determine the target application.

In some embodiments, prompt information 221 for prompting that the user 140 is currently in the application creation platform and prompt information 222 for prompting the user 140 to check and recheck the subsequently generated application may also be presented in the interface 200.

Further, in an embodiment of the present disclosure, the application management platform 110 may provide a digital assistant 120 for the user 140 to provide an interactive service for the user 140. For example, a natural language based interaction may be provided for the user 140, so that the application management platform 110 may complete the predetermined operation according to a requirement of the user 140. The predetermined operation of the at least one functional block of the target application may be determined by the interaction information of the user 140 and the digital assistant 120 in the chat window.

Depending on the specific content of the first chat message, the predetermined operation may be different. In some embodiments, where the first chat message indicates the creation of the target application, such a predetermined operation may be to combine the functional blocks that the user 140 desires to use, to create the target application. Thus, the user 140 can complete the creation of the application in an interactive manner with the digital assistant 120. For example, if the user 140 indicates to create a book management application, the digital assistant 120 may interact with the user 140 to determine the function that the user 140 needs to be included in the book management application. In turn, the application management platform 110 may create a book management application with the function desired by the user.

The digital assistant 120 may interact with the user 140 in a chat window to obtain a user input of the user 140. For example, the user 140 utilizes an input box in the chat window to input a desired function, or description information associated with the function, or a reply to a message from the digital assistant 120, etc. Accordingly, the application management platform 110 may invoke the corresponding functional block according to the function desired by the user 140 included in the target application, so as to construct the application (or provide the function currently included in the book management application for the user 140 for modification and adjustment thereof).

In some embodiments, during the interaction, the application management platform 110 may utilize the digital assistant 120 to provide the user 140 with candidate functional blocks associated with the target application and a description thereof. This allows the user 140 to select a functional block from the candidate functional blocks to achieve the desired function. For example, after the user 140 inputs the first chat message, a reply message for the first chat message may be presented in a chat window with the digital assistant 120. The reply message includes a description of the at least one candidate functional block of the target and for selection or confirmation by the user 140. The description, or in other words the description information, indicates a function that is implemented by the corresponding candidate functional block.

In some embodiments, the reply message includes at least one of the following: a text message including the description, or a preview of the at least one candidate functional block. That is, the reply message provided to the user 140 by the digital assistant 120 may be a text message describing the functional block, e.g., the name of the functional block, the function that can be realized, and so on. Alternatively or additionally, the reply message may also be a preview of at least one candidate functional block, for example, a presentation effect of a control corresponding to the candidate functional block, an implementation flow, and the like. In this way, the user 140 can more conveniently and intuitively understand at least one candidate functional block and/or combination result of the current recommendation, to assist the user 140 to better judge whether to use at least one current candidate functional block to create the target application.

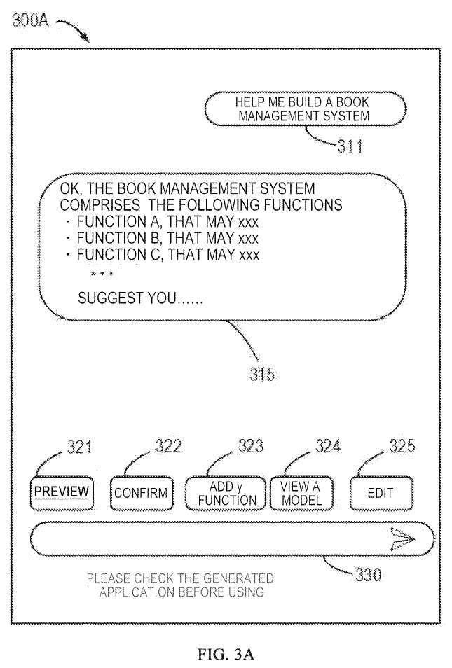

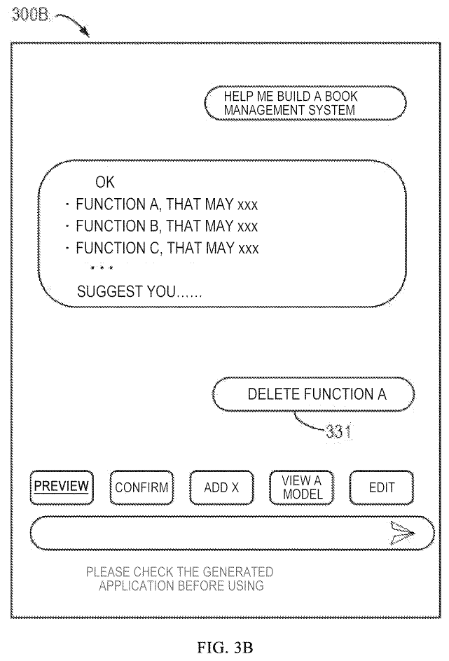

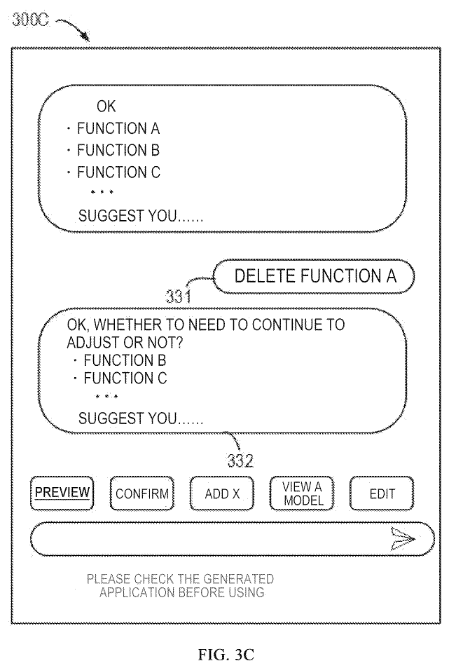

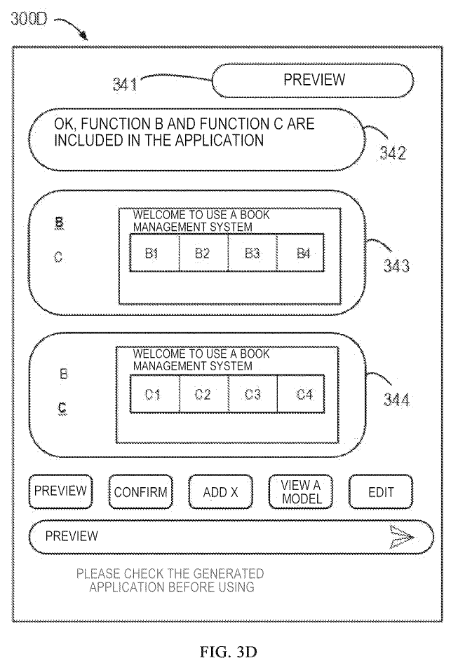

Reference is made to the example of FIG. 3A. After the user 140 inputs the first chat message 311 shown in FIG. 3A (for example, “Help me build a book management system”) in the input box 211 of the interface 200 shown in FIG. 2, the presentation interface 200 is changed to present the chat window 300A of the user and the digital assistant 120, so that the digital assistant 120 can continuously interact with the user 140 and provide an application creation service for the user 140. A reply message 315 from the digital assistant 120 is presented in the chat window 300A. The reply message 315 includes candidate functional blocks (corresponding to functions A, B, C) and description information for the user 140 to understand recommended candidate functional blocks and functions that each candidate functional block can implement. In some embodiments, a suggestion may also be provided in reply message 315 to provide user 140 with a prompt and suggestion associated with the reply message described above. For example, such a suggestion may be “Suggest you further adding function D,” “You may delete each candidate function described above,” “If you have further requirements, it is expected for you to tell me more specific expectations and appeal, I will help you create an application that more conforms to your requirements,” and so on.

The application management platform 110 may determine candidate functional blocks in any suitable manner. In some embodiments, the application management platform 110 may pre-associate the candidate functional blocks with the scene used by the application. For example, for a book management application, functional blocks for collecting book information and for adding may be pre-associated. For example, in a book management application, the function implemented by the candidate functional block may be a “add book” function that allows the user 140 to add a new book and its related information (e.g., book name, author, publication date, international standard book number ISBN), a “search book” function that allows the user 140 to search the data according to the keyword and display the book information, a “modify book information” function that allows the user 140 to modify the relevant information of the book, a “delete book” function that allows the user 140 to delete an existing book, a “borrowing management” function that allows the user 140 to manage the book's borrowing situation (e.g., borrow date, return date), a “report statistics” function that allows the user 140 to generate a statistical report (e.g., inventory, borrowing rate, etc.), and the like. Further, the digital assistant 120 may quickly provide the candidate functional block associated with this type of application to the user 140 as a reply message for the first chat message upon determining that the user desires to create the target application.

In some embodiments, application management platform 110 may utilize model 125 to determine the candidate functional blocks. For example, a prompt input for the model 125 may be generated based on the first chat message and optionally other information, and provided to the model 125. The model 125 may determine candidate functional blocks.

Further, in response to the reply message from the digital assistant 120, the user 140 may provide the second chat message in the chat window. In some embodiments, the second chat message may be used to indicate an adjustment to the at least one candidate functional block. The adjustment for the at least one candidate functional block may be to add a functional block different from the at least one candidate functional block, delete a functional block in the at least one candidate functional block, or modify at least one of the functional blocks in the at least one candidate functional block. Thus, the user 140 may quickly complete the addition, modification, and deletion for the candidate functional block based on the second chat message. For example, for a book management application, the user 140 may delete the corresponding candidate functional block by sending a “delete ‘add book’ function”. The second chat message may be input by the user 140 in an input box, or may be provided by triggering a predetermined control. For example, the user 140 may provide the second chat message of “add y function” by clicking the control 323 shown in FIG. 3A.

Referring to FIG. 3A, the user 140 may provide a second chat message “delete function A” in input box 330. Accordingly, a chat window 300B is presented in which a second chat message 331 (i.e., “delete function A”) is displayed from the user to indicate an adjustment to the candidate functional block (in this example, a candidate functional block indicated by the delete chat reply message 312).

It should be understood that the process of implementing the adjustment to the functional block by the user 140 by using the second chat message may also be multi-round. For example, after the user 140 completes one adjustment, the digital assistant 120 may query the user 140 whether to complete the adjustment (e.g., send the query information “Have you completed the adjustment”). In this case, if the user 140 completes the adjustment, the user 140 may send, for example, “confirm” and “no more adjustment” to feed back that the adjustment is completed. If the user 140 needs to continue to adjust, the functional block may be adjusted again by using the new second chat message.

For example, reference is made to the chat window 300C. In the chat window 300C, a further reply message 332 is displayed from the digital assistant 120 for the second chat message 331.

Example chat messages and reply messages between user 140 and digital assistant 120 are described above. The user 140 and the digital assistant 120 may perform multi-round interaction in the chat window. Based on the interaction information in the chat window, the application management platform 110 may determine a predetermined operation for at least one functional block of the target application.

In some embodiments, the application management platform 110 may utilize the model 125 to determine the predetermined operation. For example, the application management platform 110 may generate, based at least on the interaction information, a prompt input for the model 125 (to facilitate distinguishing from a subsequently involved prompt input, such a prompt input may be for example referred to as a first prompt input), and provide the first prompt input to the model 125. The application management platform 110 may obtain an indication regarding a predetermined operation from the model 125. The indication regarding the predetermined operation may include any suitable form of information that the application management platform 110 can use to perform the predetermined operation. For example, the indication may be text describing the step of performing the predetermined operation. As another example, the indication may be an intermediate language code that can be used by the application management platform 110 to implement a predetermined operation. For another example, if the operation that the application management platform can perform has a corresponding index, the indication may be an index of a predetermined operation.

Specifically, after obtaining the interaction information input by the user 140, the interaction information may be processed to determine a first prompt input (for short, a first prompt). The first prompt input may include a requirement of the user with respect to the target application and information for meeting the requirement. For example, the application management platform 110 may process the interaction information of “Help me build a book management application” by using a word segmentation manner, to remove “Help me” therein, to obtain a prompt “build a book management application”. Further, the application management platform 110 may process the “build a book management application” by using the model 125 (for example, the model 125) to obtain an indication regarding a predetermined operation.

In some embodiments, to better utilize the model 125, the digital assistant 120 may generate the first prompt input based on the corresponding description information of the plurality of functional blocks. The description information for each functional block includes at least a semantic description of the function of the functional block. In particular, the semantic description may be in the form understandable by the model 125. The understandable form may refer to that the language, format, and the like of the text meet preset requirements of the model 125. Alternatively or additionally, the model 125 may also pre-provide the form, content, scope, etc. of the semantic descriptions it may understand to the application management platform 110 such that the application management platform 110 may learn the form of semantic descriptions that may be understood by the model 125 based on the semantic descriptions pre-provided. Therefore, the corresponding description information of the functional blocks can be processed based on the form to obtain the semantic description with higher quality.

Similarly, in some embodiments, if the first chat message indicates the modification of the target application, the application management platform 110 presents the currently existing functional blocks in the target application to the user 140 in a similar manner, to allow the user 140 to adjust the functional blocks. For example, the application management platform 110 may perform at least one of removing a functional block in at least one functional block in the target application, adding a functional block in the at least one functional block to the target application, and updating at least one operation already existing in the functional block of the target application in the at least one functional block according to the interaction message of the user 140 in the chat window, to complete the adjustment and update of the target application.

In some embodiments, a preview of at least a portion of a target application having at least one functional block may be presented in a chat window. In particular, a preview of the target application (e.g., a preview of the interface of the target application) created based on at least one current functional block may be provided in the chat window, so that the user 140 understands the combined effect of the functional block to be currently used based on the preview. Therefore, the user 140 can more directly understand the effect of the target application to be formed, and get the help for adjusting the functional block.

The preview of the interface may be provided based on an indication of the user 140 and/or based on historical behavior of the user 140. For example, a preview (e.g., a preview of an interface) may be presented in response to receiving a “preview” message sent by user 140 in a chat window. As shown in chat window 300D, user 140 may send a “preview” with an input box to obtain a preview (e.g., presented preview 343 and preview 344).

Alternatively or additionally, an entry control for implementing the preview may also be provided in the chat window, such that the user 140 may utilize the entry control to acquire the preview. For example, in the chat window 300A, the digital assistant 120 may provide the control 321 as an entry for implementing the preview, so that the user 140 may obtain the preview of the interface of the target application by using the control 321.

In some embodiments, where the user 140 is allowed to adjust the candidate functional block based on multiple rounds of interaction, a threshold round may also be maintained in the digital assistant 120. In the event that the interaction round by the user 140 reaches the threshold round, a preview is presented to the user 140 for better and faster decision.

In some embodiments, the preview of the target application may be a preview of a portion of content of the target application, for example, a navigation bar in the target application, an operation main interface, or the like. Therefore, while making it convenient for user 140, it also improves the speed of preview generation. Alternatively or additionally, a preview may be provided separately for various functional blocks included in the target application. For example, in the example of FIG. 3D, preview 343 may be provided for a state in which function B is activated, and preview 344 may be provided for a state in which function C is activated. In this way, the user 140 can more clearly understand the state when the functions in the application are each activated.

Further, the user 140 may confirm the predetermined operation described above, and the user may confirm the creation of the target application and modification of a certain module corresponding to the target application. For example, the user 140 may complete the confirmation of the predetermined operation by sending a “confirm” chat message in the chat window. Alternatively or additionally, a control for confirming the predetermined operation may be provided in the chat window, such as confirmation control 322 shown in FIG. 3A. This may enable the user 140 to quickly complete the confirmation. For example, such a control 322 may be used to indicate that at least one functional block is combined to create a target application.

In addition to the controls described above, more controls may also be provided in the chat window to assist the user 140 in quick input. For example, FIG. 3A illustrates a control 324 for viewing a data model of a target application.

In an embodiment of the present disclosure, the application management platform 110 may perform a predetermined operation on the at least one functional block in response to the confirmation of the user 140 (for example, for creating the target application, or modifying the target application). Where the first chat message indicates the creation of the target application, the application management platform 110 may combine the at least one functional block confirmed by the user 140 to create the target application. Where the first chat message indicates the modification of the target application, the application management platform 110 may remove one or more existing functional blocks from the target application, or add one or more new functional blocks to the target application, or update one or more existing functional blocks of the target application.

To create an application for example, the predetermined operation may be represented as a domain-specific language (for short, DSL) that the application management platform 110 can use. For example, the code corresponding to the function conversion module and read by the application creation platform may be invoked to create a target application having at least one functional block.

In order to meet the requirements of different users, for example, to meet the differentiated demands of users with difference development level, the digital assistant 120 may also be configured with different usage modes, for example, a digital assistant dominant mode (also referred to as a first mode) and a digital assistant assistance mode (also referred to as a second mode). In embodiments of the present disclosure, in the digital assistant dominant mode, the application management platform 110 may perform the application management operation through interaction of the user 140 with the digital assistant 120 in the chat window without an application editing interface (e.g., in the interaction manner illustrated by the chat window 300A, the chat window 300B). For example, in the case that the user 140 expresses its requirement in pure natural language, the application management operation may be performed based on the understanding of natural language provided by the user 140, for example, the configuration and construction of functions in the application are completely completed. For example, for a digital assistant dominant mode, the target application may be created or modified only by the interaction of the digital assistant 120 with the natural language form of the user 140. The above described may be considered a digital assistant dominant mode.

In the digital assistant assistance mode, the application management platform 110 may provide an application editing interface for the user 140, and execute the application management operation through user interaction in the application editing interface. User interactions may include chat content (e.g., natural language, media content, links, etc.) of the user with the digital assistant 120 and user interactions with the interface elements. That is, in the digital assistant assistance mode, the user 140 may be allowed to express requirements in a plurality of ways of interaction. For example, the user 140 may select to edit the target application by dragging the interface element, or may provide the natural language input to edit the target application. The user 140 may select an interaction manner to complete the editing according to his habits, preferences, or specific editing operations. For example, some editing operations are more convenient by interacting with interface elements (e.g., dragging), while some editing operations are more convenient to express in natural language. Further, in the digital assistant assistance mode, the user 140 is provided with a visual application editing interface that the user 140 can make more careful adjustments (e.g., adjust display parameters, colors, element shapes, etc. in the functional blocks) for the content included in the functional blocks. In this way, in the case where the overall framework of the application has been created, refinement adjustment of the application can be done more conveniently and efficiently in the digital assistant assistance mode.

It should be understood that the user 140 may separately utilize the digital assistant dominant mode, and complete creation or modification of the target application based on the first chat message indicating the target application. The user 140 may also edit the functional block using the digital assistant assistance mode after creation or modification of the target application using the digital assistant dominant mode, and complete the final target application using the edited functional block. Also for example, user 140 may separately utilize a digital assistant assistance mode (e.g., direct click control 325 into a digital assistant assistance mode) for selection and editing of functional blocks. Alternatively or additionally, a control for entering, triggering a digital assistant assistance mode may also be provided for selection by the user 140 (e.g., the control 325 illustrated in the chat window 300A). Alternatively or additionally, a mode more suitable for the current user may also be provided first depending on the user's profile (e.g., application development capabilities or preferences), etc.

In the digital assistant assistance mode, an interface may be presented for editing the created target application. If the adjustment request (e.g., represented in natural language) for at least a portion of the target application is received in the editing interface, the at least a portion may be adjusted. Having created the target application, utilizing the information related to the target application may help the model 125 more accurately determine the adjustment operation to be performed. To this end, in some embodiments, the second prompt input for the model 125 may be generated based on the adjustment request and the information related to the target application. As an example, the information related to the target application may include description information of a functional block that has been created by the target application, for example, a function parameter, a display parameter, a color, an element shape, and the like of the functional block. Further, the second prompt input may be provided to the model 125, which determines an adjustment operation to be performed based on the second prompt input. The application management platform 110 obtains an indication regarding the adjustment operation from the model 125 and performs the adjustment operation on at least a portion of the target application.

Further, the switching of the digital assistant dominant mode and the digital assistant assistance mode may be implemented in a number of ways. In some embodiments, the switching may be active by the application management platform 110. The application management platform 110 may switch to the digital assistant assistance mode if the predetermined operation is completed. That is, an editing interface may be provided that allows the user 140 to more finely edit the target application. For example, in case of the application creation, after the predetermined operation of the application creation is completed, or after the target application has been created, the application management platform 110 may present an interface for editing the interface to the user 140, to assist the user 140 in further editing the target application.

In some embodiments, the switching may be in response to a trigger by the user 140. For example, upon completion of the creation of the target application, if the user 140 desires to further adjust the target application, the user 140 may adjust the target application by inputting an adjustment instruction (e.g., “adjustment”) in the input box and/or entering the digital assistant assistance mode using the example control 325.

Alternatively or additionally, in some embodiments, the switching may be accomplished in response to a preset condition being satisfied. For example, when the interaction between the user 140 and the digital assistant 120 in the chat window meets a preset condition (for example, the interaction round reaches a preset threshold round), the digital assistant dominant mode is switched to the digital assistant assistance mode. Thus, the digital assistant assistance mode is entered according to the usage of the user 140 to better serve the user 140. Similarly, in the case of “modifying” the target application, the editing interface may also be provided in the case that the predetermined operation for “modification” is completed, which will not be repeated here.

In some embodiments, a chat window of the user 140 and the digital assistant 120 may be provided in the editing interface, and the chat window may include an input box for obtaining an input of the user 140, so that the user 140 may also complete the adjustment based on the interaction. Further, at least a portion of the target application may be adjusted according to an adjustment request (for example, represented in natural language) for at least a portion of the target application in the editing interface. For example, some content in a functional block may be adjusted. Thus, application creation, customization services may be provided more finely for the user 140. In some embodiments, at least a portion of the target application may be adjusted based on a user interaction context associated with the adjustment request. The user interaction context may indicate whether the adjustment request is made for a particular one or more portions of the target application. For example, the user interaction context may include whether a particular portion is selected upon receiving the adjustment request.

For example, interface 400A and subsequent interfaces 400B and 400C may each be provided to user 140 as an editing interface. Digital assistant 120 may change from presentation chat window 300D to presentation interface 400A if user 140 desires to adjust the target application. In interface 400A, there may be at least 3 regions, such as region 410 for presenting adjusted content associated with the functional block, region 420 for presenting the target application, and chat window 430 for presenting interaction with user 140. Alternatively or additionally, the chat window 430 may be presented in the form of a floating window to facilitate the user 430 to adjust the presentation location of the chat window 430 as needed. In region 410, a plurality of sub-regions 412-414 may be provided in association with functional blocks to present content that can be adjusted for functional blocks, respectively. In the region 410, the navigation region 411 may also be presented to provide, for example, the function of performing a search on the functional blocks, thereby facilitating the user 140 to complete the configuration more quickly and conveniently for the functional blocks required for the search. Further, an input box 431 is presented in the chat window 430, so that the user 140 can input an adjustment request (for example, change “X” in the function B to “XX”) by using the input box 431. Further, the digital assistant 120 adjusts “X” in function B to “XX” based on the adjustment request.

In some embodiments, to facilitate user 140 to edit, user 140 may be allowed to select a portion where he/she desires to adjust and provide an adjustment request (e.g., represented in natural language) if the portion is selected. For example, the user 140 may designate the portion where he/she expects to adjust by, for example, a click and box selection, in the editing interface. Accordingly, the application management platform 110 may determine the target portion to be adjusted by the target application based on such user interaction context, and adjust the target portion. For example, where the user 140 selects a portion of the target application based on a click, box selection, etc., a requirement for the content integrity of the content input by the user 140 in the input box 431 may be reduced. For example, for “X” in function B, after it is selected by user 140, user 140 may input “change to ‘XX’”, without completely entering “chang ‘X’ in function B to ‘XX’”. Therefore, the user 140 can conveniently perform the editing operation. It should be understood that a click, box selection may allow the user 140 to select multiple modified portions or elements simultaneously. For example, user 140 may indicate an adjustment to function B and function C in whole by way of box selection of function B, function C.

Accordingly, where there is a selected portion, an adjustment operation may be determined based on the information related to the selected portion and the adjustment request, and the adjustment operation is performed on the selected portion. For example, the prompt input of the model 125 may be determined based on the information related to the selected portion and the adjustment request, thereby obtaining the adjustment operation determined by the model 125. Therefore, the portion that needs to be adjusted and the content to be adjusted can be determined and associated more quickly, and the adjustment efficiency for the target application is improved.

In some embodiments, to facilitate the user 140 to edit, for example, to enable the user 140 to more clearly understand the modified content and more quickly indicate the modified content, the layout of the editing interface may be adjusted, so that more content may be presented in the editing interface. The digital assistant 120 may also present the interface for providing the adjustment request at a location associated with at least a portion in the editing interface. For example, where the user 140 selects the first portion, an interface of natural language input may be provided in association with selected first portion. In particular, the digital assistant 120 may present an interface (e.g., an input box) for obtaining the adjustment request at a location associated with the content presented in the target application. For example, if the user 140 selects a certain portion, a natural language interface may be presented in association with the portion for the user 140 to provide its adjustment request. As another example, the natural language interface may be stowed, and if the user 140 selects the portion, the natural language interface may be expanded for user 140 to input.

Continuing with the example above, for “X” under function B item, the digital assistant 120 may provide the interface of the natural language input in association with the location of “X” under the function B item (e.g., present the interface at the location preset distance from the “X” under the function B item) in case it is determined that the user 140 desires to adjust the “X” under the function B item (e.g., place the operation pointer at the location of “X” under the function B item) to facilitate the user 140 to use. Alternatively or additionally, it may also be possible to determine whether to provide an interface for the user 140 to acquire the natural language input (e.g., provide the interface after the hover time exceeds the time threshold) by judging whether the time that the pointer hovers over a particular location (e.g., the location of the “X” under the function B item) exceeds a time threshold.

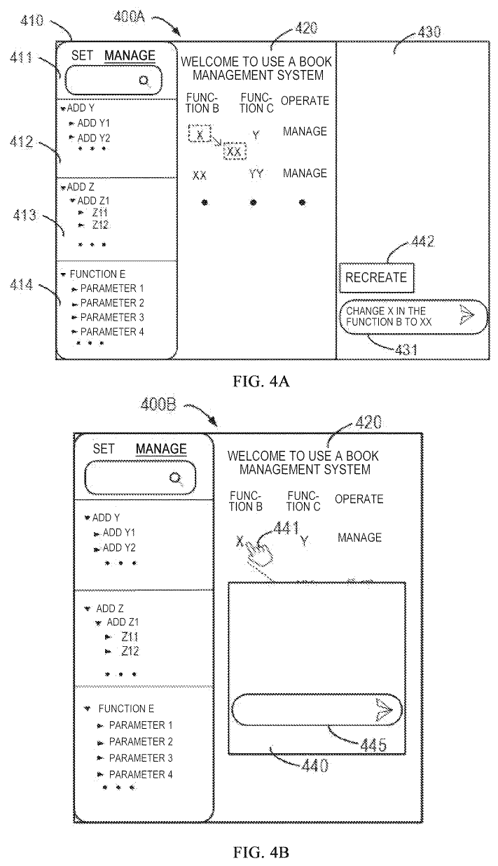

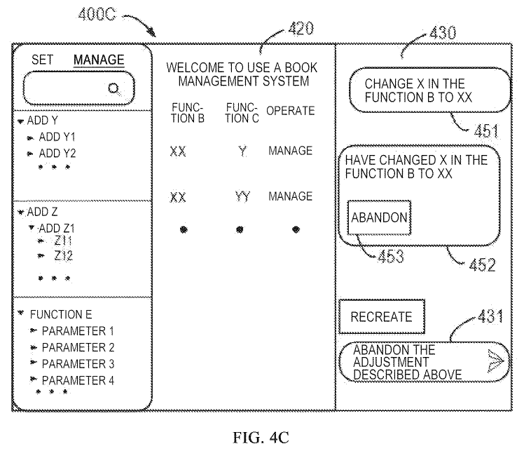

For example, reference may be made to FIG. 4B, when the pointer 441 indicates the location of “X” under the function B, the digital assistant 120 may present the chat window 440 including the input box 445 or only the input box 445 at a location associated with the “X” under the instruction function B. After the user 140 provides the adjustment request (for example, represented in natural language) by using the input box 445 as the interface, the application management platform 110 adjusts “X” under the function B item based on the content entered in the input box 445.

In such embodiments, the user interaction context is that the interface that received the adjustment request is associated with a certain portion of the target application. Accordingly, the adjustment operation may be determined based on the information related to the portion and the adjustment request, and the adjustment operation may be performed on the portion.

In some embodiments, the user 140 does not select a particular portion of the target application, e.g., the user 140 invokes a chat window of the digital assistant 120 based on the assistant invocation control and interacts directly based on the chat window. In this case, the user 140 does not indicate the portion of the target application through the previous interaction, and may determine, based on the information related to the target application and the adjustment request, the portion of the target application desired to be adjusted by the user 140 (which may be referred to as the second portion for the illustrative purpose and for ease of understanding) and the adjustment operation. Correspondingly, the adjustment operation is performed on the second portion.

In some embodiments, the second portion desired to be adjusted by the user 140 may be a portion not displayed in the current editing interface. In this case, another editing interface may be presented in which the second portion is displayed. Therefore, the user 140 can intuitively understand the content of the adjusted portion and the adjustment result based on the editing interface, and assist the user 140 to better complete the adjustment of the target application. In addition, the user 140 does not need to give an editing interface switching instruction.

In some embodiments, the application management platform 110 may also receive a user indication (also referred to as an abandon indication) to abandon an adjustment to at least a portion, and respond to the user indication to restore the target application to the version prior to the adjustment. For example, after viewing the adjusted effect, the user 140 may consider that the effect prior to the adjustment is better. In this case, the user 140 may instruct the application management platform 110 to abandon the previously made adjustments by interacting with the digital assistant.

Such an abandon indication may be provided in a variety of suitable manners. For example, the user 140 may provide an abandon indication in natural language in a chat window with the digital assistant. For example, reference may be made to FIG. 4C, in the interface 400C shown in FIG. 4C. After providing the adjustment request 451 by using the input box 431, the user 140 may again input “abandon the adjustment described above” by using the input box 431.

In some embodiments, control may be provided to the user for the user 140 to conveniently give an abandon indication. For example, upon completion of the adjustment for the adjustment request by the user 140, the digital assistant 120 may provide a chat message for the user 140 to indicate that the adjustment to the portion desired to be adjusted by the user 140 is completed. Further, a control for abandoning adjustment may also be presented at a location associated with the chat message. If the user triggers (e.g., clicks) the control, the target application may be restored to the version prior to the adjustment. In this way, the user 140 may quickly abandon relevant adjustments based on triggering of the control. Therefore, it is more convenient for the user 140 to implement adjustment of the target application. For example, reference may be continuously made to FIG. 4C, the digital assistant 120 returns the chat message 452 for the adjustment request 451. The control 453 may be presented together in the chat message 452 such that the user 140 may indicate the abandonment of the adjustment by way of the trigger control 453.

In some embodiments, the user 140 may be allowed to close the chat window with the digital assistant 120 as needed. If a closing operation for the chat window is received, the chat window may be stopped from being displayed in the editing interface. Thus, the user may focus the attention on the review application. Meanwhile, a control for re-opening the chat window is presented in the editing interface, so that the user continues to provide the adjustment request when needed. For example, an assistant invocation control may be displayed at any suitable location in interface 400A. The chat window 430 may be presented in a case where the assistant invocation control is triggered by the user 140. Correspondingly, in a case where the user 140 triggers the close control, the chat window 430 may be closed, and the assistant invoking control may be presented again, so that the user 140 continues to select to present and close the chat window 430.

In addition, in some embodiments, the user 140 may also enter the editing interface by, for example, clicking the control 325, to edit and obtain the target application. Its editing mode is similar to that of the existing target application, which will not be repeated here.

Alternatively or additionally, a control 442 may also be provided in the editing interface to indicate the re-creation of the application. The control 442 may be triggered (e.g., clicked) by the user 140 to indicate to recreate the currently generated target application, or to open the creation of other target applications (e.g., such a control 442 may be used to instruct the digital assistant to delete the current target application and recreate).

In some embodiments, if a user 140 input that abandons the created target application (e.g., user 140 clicking control 442), change may occur from an editing interface (e.g., interface 400A) to interface 200 of the above example or a chat window of user 140 with digital assistant 120 for recreating the application or other application. For example, a chat message (e.g., recreating the current application, or creating other applications, etc.) related to application creation from user 140 may be received in a chat window in a jumped interface and operations determined based on the chat message are completed. In this way, the user 140 can abandon the generated applications as a whole based on the requirements, and the operation efficiency of the user 140 is improved. Alternatively or additionally, for the case of modifying the target application, the user 140 may similarly be allowed to abandon the modification of the target application, that is, the existing functional block of the target application is not adjusted.

The digital assistant assistance mode provides a more flexible selection for the user. The user may decide whether to use a natural language chat manner or a traditional manner (e.g., dragging, selecting, etc. of the element to be adjusted) to complete the adjustment according to the personal operation habit or the specific adjustment operation.

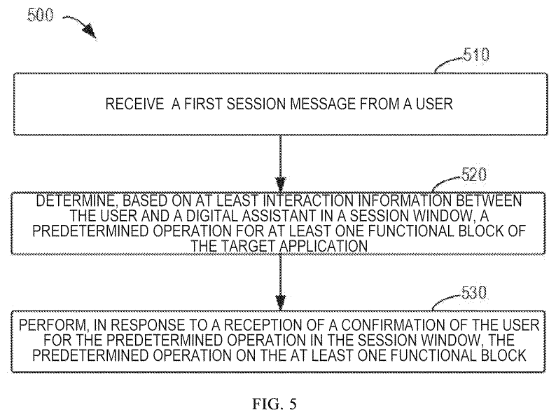

FIG. 5 illustrates a flowchart of a process 500 for managing an application according to some embodiments of the present disclosure. Process 500 may be implemented at application management platform 110. The process 500 is described below with reference to FIG. 1.

At block 510, receiving a first chat message from a user. In an embodiment of the present disclosure, the first chat message indicating creation or modification of a target application.

At block 520, determining, based on at least interaction information between the user and a digital assistant in a chat window, a predetermined operation for at least one functional block of the target application.

At block 530, performing, in response to a reception of a confirmation of the user for the predetermined operation in the chat window, the predetermined operation on the at least one functional block.

In some embodiments, the interaction information comprises at least: a reply message of the digital assistant presented in the chat window to the first chat message, the reply message comprising a description of at least one candidate functional block of the target application; and a second chat message from the user received in the chat window.

In some embodiments, the second chat message indicates: adjustment to the at least one candidate functional block, confirmation of the reply message, or negation of the reply message.

In some embodiments, the adjustment to the at least one candidate functional block comprises at least one of: addition of a functional block different from the at least one candidate functional block, deletion of a functional block in the at least one candidate functional block, or modification of a functional block in the at least one candidate functional block.

In some embodiments, the reply message comprises at least one of: a text message comprising the description, or a preview of the at least one candidate functional block.

In some embodiments, determining the predetermined operation comprises: generating a first prompt input for a model based on at least the interaction information; providing the first prompt input to the model; and obtaining an indication regarding the predetermined operation from the model.

In some embodiments, the first prompt input is generated further based on respective description information of a plurality of functional blocks, the description information of each functional block comprising at least a semantic description regarding a function of the functional block.

In some embodiments, the process 500 further comprises: presenting, in the chat window, a preview of at least a portion of the target application having the at least one functional block.

In some embodiments, the process 500 further comprises: presenting an interface for editing the created target application; and adjusting at least a portion of the target application, in response to a reception of an adjustment request for the at least a portion of the target application in the interface.

In some embodiments, presenting the interface is responsive to at least one of: a trigger operation from the user to switch to the interface; completion of the predetermined operation; the interaction between the user and the digital assistant in the chat window meeting a preset condition.

In some embodiments, the process 500 further comprises: presenting the chat window in place of the interface in response to receiving a user input to abandon the created target application.

In some embodiments, the process 500 further comprises: presenting an interface for providing the adjustment request at a location of the interface associated with the at least a portion; and receiving the adjustment request via the interface.

In some embodiments, adjusting the at least a portion comprises: generating a second prompt input for the model based on the adjustment request and information related to the target application; providing the second prompt input to the model; obtaining an indication regarding an adjustment operation from the model; and performing the adjustment operation on the at least a portion.

In some embodiments, receiving the user input comprises: presenting an input box for the user to provide the text and information prompting the user to create an application; and receiving the user input via the input box.

In some embodiments, the first chat message indicates creation of the target application, and performing the predetermined operation on the at least one functional block comprises: combining the at least one functional block to create the target application.

In some embodiments, the first chat message indicates modification of the target application, and performing the predetermined operation on the at least one functional block comprises at least one of: removing a functional block of the at least one functional block from the target application, adding a functional block of the at least one functional block to the target application, or updating a functional block of the at least one functional block already existing in the target application.

In some embodiments, the digital assistant is provided by a PaaS based platform.

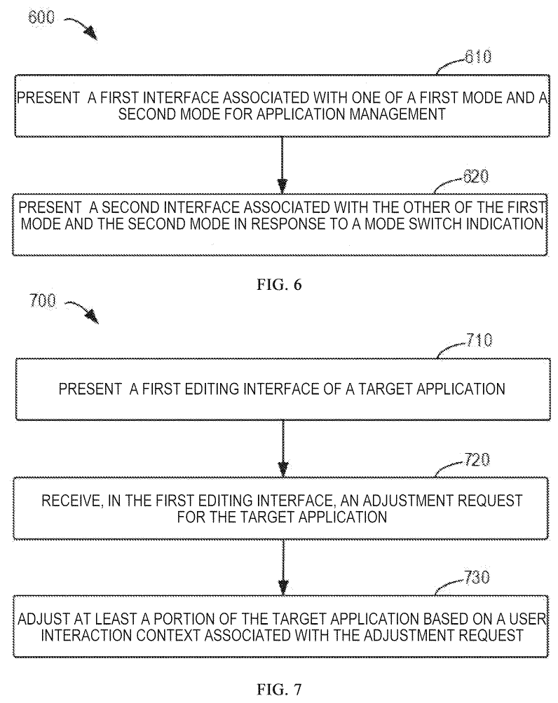

FIG. 6 illustrates a flowchart of a process 600 for managing an application according to some other embodiments of the present disclosure. Process 600 may be implemented at application management platform 110. The process 600 is described below with reference to FIG. 1.

Block 610, presenting a first interface associated with one of a first mode and a second mode for application management.

Block 620, presenting a second interface associated with the other of the first mode and the second mode in response to a mode switch indication. In an embodiment of the present disclosure, in the first mode, an application management operation is performed by an interaction between a user and a digital assistant in a chat window without an application editing interface, and in the second mode, an application management operation is performed by a user interaction in an application editing interface.

In some embodiments, the first interface is associated with the first mode, and the mode switch indication comprises: a trigger operation from the user to switch to the second mode, completion of a predetermined operation for at least one functional block of a target application, or the interaction between the user and the digital assistant in the chat window meeting a preset condition.

In some embodiments, the first interface is associated with the second mode, and the mode switch indication comprises: a trigger operation from the user to switch to the first mode, a user input indicating to abandon the created application, or a user input indicating to create a new application.

FIG. 7 illustrates a flowchart of a process 700 for managing an application according to still other embodiments of the present disclosure. Process 700 may be implemented at application management platform 110. The process 700 is described below with reference to FIG. 1.

At block 710, presenting a first editing interface of a target application.

At block 720, receiving, in the first editing interface, an adjustment request for the target application.

At block 730, adjusting at least a portion of the target application based on a user interaction context associated with the adjustment request.

In some embodiments, adjusting the at least a portion comprises: determining, in response to the user interaction context indicating that a first portion of the target application is selected, a first adjustment operation based on the information related to the first portion and the adjustment request; and performing the first adjustment operation on the first portion.

In some embodiments, the user interaction context comprises at least one of: the adjustment request received in response to the first portion being selected, or the adjustment request received via an interface presented at a location associated with the first portion.

In some embodiments, adjusting the at least a portion comprises: determining, in response to the user interaction context indicating that a specific portion of the target application is not selected, a second portion and a second adjustment operation of the target application based on the information related to the target application and the adjustment request; and performing the second adjustment operation on the second portion.

In some embodiments, the second portion is a portion of the target application not displayed in the editing interface, the method further comprises: presenting a second editing interface of the target application, wherein the second portion is displayed in second editing interface.

In some embodiments, process 700 further comprises: receiving a user indication to abandon the adjustment to the at least a portion; and restoring the target application to a version prior to the adjustment in response to the user indication.

In some embodiments, receiving the user indication comprises: presenting a chat message from a digital assistant, the chat message indicating that the adjustment to the at least a portion has been completed; presenting a control for abandoning the adjustment at a location associated with the chat message; and receiving a trigger operation on the control.

In some embodiments, a chat window with a digital assistant is displayed in the first editing interface, and the method further comprises: stopping displaying the chat window in the first editing interface in response to a closing operation for the chat window; and displaying a control for reopening the chat window in the first editing interface.

In some embodiments, adjusting the at least a portion comprises: generating a prompt input for a model based on the adjustment request and the information related to the target application; providing the prompt input to the model; obtaining an indication regarding an adjustment operation from the model; and performing the adjustment operation on the at least a portion.

FIG. 8 illustrates a schematic structural block diagram of an apparatus 800 for managing an application according to some embodiments of the present disclosure. The apparatus 800 may be implemented or included in the application management platform 110. The various modules/components in the apparatus 800 may be implemented by hardware, software, firmware, or any combination thereof.

As shown, the apparatus 800 comprises: a first receiving module 810, configured to receive a first chat message from a user, the first chat message indicating creation or modification of a target application. The apparatus 800 further comprises: a determining module 820 configured to determine, based on at least interaction information between the user and a digital assistant in a chat window, a predetermined operation for at least one functional block of the target application. The apparatus 800 further comprises: a performing module 830 configured to perform, in response to a reception of a confirmation of the user for the predetermined operation in the chat window, the predetermined operation on the at least one functional block.

In some embodiments, the interaction information comprises at least: a reply message of the digital assistant presented in the chat window to the first chat message, the reply message comprising a description of at least one candidate functional block of the target application; and a second chat message from the user received in the chat window.

In some embodiments, the second chat message indicates: adjustment to the at least one candidate functional block, confirmation of the reply message, or negation of the reply message.

In some embodiments, the adjustment to the at least one candidate functional block comprises at least one of: addition of a functional block different from the at least one candidate functional block, deletion of a functional block in the at least one candidate functional block, or modification of a functional block in the at least one candidate functional block.

In some embodiments, the reply message comprises at least one of: a text message comprising the description, or a preview of the at least one candidate functional block.

In some embodiments, the determining module 820 is further configured to: generate a first prompt input for a model based on at least the interaction information; provide the first prompt input to the model; and obtain an indication regarding the predetermined operation from the model.

In some embodiments, the first prompt input is generated further based on respective description information of a plurality of functional blocks, the description information of each functional block comprising at least a semantic description regarding a function of the functional block.

In some embodiments, the apparatus 800 further comprises: a preview module, configured to present, in the chat window, a preview of at least a portion of the target application having the at least one functional block.

In some embodiments, the apparatus 800 further comprises: a second adjustment module, configured to present an interface for editing the created target application; and adjust at least a portion of the target application, in response to a reception of an adjustment request for the at least a portion of the target application in the interface.

In some embodiments, presenting the interface is responsive to at least one of: a trigger operation from the user to switch to the interface; completion of the predetermined operation; the interaction between the user and the digital assistant in the chat window meeting a preset condition.

In some embodiments, further comprises: a replacement module, configured to: present the chat window in place of the interface in response to receiving a user input to abandon the created target application.

In some embodiments, further comprises: an interface module, configured to present an interface for providing the adjustment request at a location of the interface associated with the at least a portion; and receive the adjustment request via the interface.

In some embodiments, the second adjustment module is further configured to: generate a second prompt input for the model based on the adjustment request and information related to the target application; provide the second prompt input to the model; obtain an indication regarding an adjustment operation from the model; and perform the adjustment operation on the at least a portion.

In some embodiments, the interface module is further configured to: present an input box for the user to provide the text and information prompting the user to create an application; and receive the user input via the input box.

In some embodiments, the first chat message indicates creation of the target application, and performing the predetermined operation on the at least one functional block in the performing module 830 comprises: combining the at least one functional block to create the target application.

In some embodiments, the first chat message indicates modification of the target application, and performing the predetermined operation on the at least one functional block comprises at least one of: removing a functional block of the at least one functional block from the target application, adding a functional block of the at least one functional block to the target application, or updating a functional block of the at least one functional block already existing in the target application.

In some embodiments, the digital assistant is provided by a PaaS based platform.

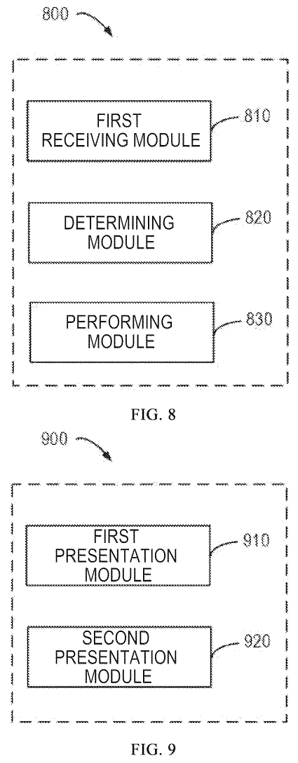

FIG. 9 illustrates a schematic structural block diagram of an apparatus 900 for managing an application according to some embodiments of the present disclosure. The apparatus 900 may be implemented or included in the application management platform 110. The various modules/components in the apparatus 900 may be implemented by hardware, software, firmware, or any combination thereof.

As shown, the apparatus 900 comprises: a first presentation module 910, configured to present a first interface associated with one of a first mode and a second mode for application management. The apparatus 900 further comprises: a second presentation module 902, configured to present a second interface associated with the other of the first mode and the second mode in response to a mode switch indication, and wherein in the first mode, an application management operation is performed by an interaction between a user and a digital assistant in a chat window without an application editing interface, and in the second mode, an application management operation is performed by a user interaction in an application editing interface.

In some embodiments, the first interface is associated with the first mode, and the mode switch indication comprises: a trigger operation from the user to switch to the second mode, completion of a predetermined operation for at least one functional block of a target application, or the interaction between the user and the digital assistant in the chat window meeting a preset condition.

In some embodiments, the first interface is associated with the second mode, and the mode switch indication comprises: a trigger operation from the user to switch to the first mode, a user input indicating to abandon the created application, or a user input indicating to create a new application.

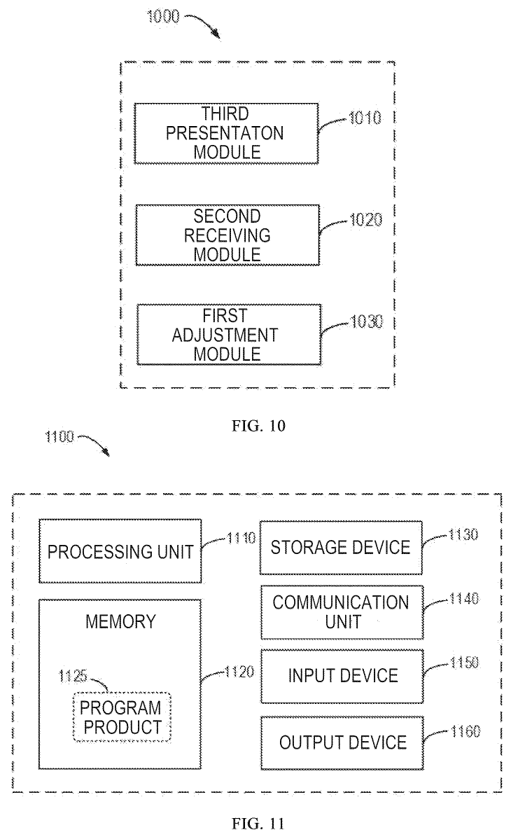

FIG. 10 illustrates a schematic structural block diagram of an apparatus 1000 for managing an application according to some embodiments of the present disclosure. The apparatus 1000 may be implemented or included in the application management platform 110. The various modules/components in the apparatus 1000 may be implemented by hardware, software, firmware, or any combination thereof.

As shown, the apparatus 1000 comprises: a third presentaton module 1010, configured to present a first editing interface of a target application. The apparatus 1000 further comprises: a second receiving module 1020, configured to receive, in the first editing interface, an adjustment request for the target application. The apparatus 1000 further comprises: a first adjustment module 1030, configured to adjust at least a portion of the target application based on a user interaction context associated with the adjustment request.

In some embodiments, the first adjustment module 1030 is further configured to: determine, in response to the user interaction context indicating that a first portion of the target application is selected, a first adjustment operation based on the information related to the first portion and the adjustment request; and perform the first adjustment operation on the first portion.

In some embodiments, the user interaction context comprises at least one of: the adjustment request received in response to the first portion being selected, or the adjustment request received via an interface presented at a location associated with the first portion.

In some embodiments, the first adjustment module 1030 is further configured to: determine, in response to the user interaction context indicating that a specific portion of the target application is not selected, a second portion and a second adjustment operation of the target application based on the information related to the target application and the adjustment request; and perform the second adjustment operation on the second portion.

In some embodiments, the second portion is a portion of the target application not displayed in the editing interface, and the apparatus 1000 further comprises: a fourth presentation module, configured to present a second editing interface of the target application, where the second editing interface displays the second portion.

In some embodiments, the apparatus 1000 further comprises: a restoration module, configured to receive a user indication to abandon the adjustment to the at least a portion; and restore the target application to a version prior to the adjustment in response to the user indication.

In some embodiments, the restoration module is further configured to: present a chat message from a digital assistant, the chat message indicating that the adjustment to the at least a portion has been completed; present a control for abandoning the adjustment at a location associated with the chat message; and receive a trigger operation on the control.

In some embodiments, a chat window with a digital assistant is displayed in the first editing interface, and the apparatus 1000 further comprises: a replay module, configured to: stop displaying the chat window in the first editing interface in response to a closing operation for the chat window; and display a control for reopening the chat window in the first editing interface.

In some embodiments, the first adjustment module 1030 is further configured to: generate a prompt input for the model based on the adjustment request and information related to the target application; provide the prompt input to the model; obtain an indication regarding an adjustment operation from the model; and perform the adjustment operation on the at least a portion.

FIG. 11 illustrates a block diagram illustrating an electronic device 1100 in which one or more embodiments of the present disclosure may be implemented. It should be understood that the electronic device 1100 illustrated in FIG. 11 is merely illustrative and should not constitute any limitation on the function and scope of the embodiments described herein. The electronic device 1100 illustrated in FIG. 11 may be configured to implement the application management platform 110 in FIG. 1.

As shown in FIG. 11, the electronic device 1100 is in the form of a general-purpose electronic device. Components of the electronic device 1100 may include, but are not limited to, one or more processors or processing units 1110, a memory 1120, a storage device 1130, one or more communication units 1140, one or more input devices 1150, and one or more output devices 1160. The processing unit 1110 may be an actual or virtual processor and capable of performing various processes according to programs stored in the memory 1120. In multiprocessor systems, multiple processing units execute computer-executable instructions in parallel to improve parallel processing capabilities of electronic device 1100.

Electronic device 1100 typically includes a plurality of computer storage media. Such media may be any available media accessible to the electronic device 1100, including, but not limited to, volatile and non-volatile media, removable and non-removable media. The memory 1120 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 1130 may be a removable or non-removable medium and may include a machine-readable medium, such as a flash drive, magnetic disk, or any other medium, which may be capable of storing information and/or data and may be accessed within electronic device 1100.

The electronic device 1100 may further include additional removable/non-removable, volatile/non-volatile storage media. Although not shown in FIG. 11, a disk drive for reading or writing from a removable, non-volatile magnetic disk (e.g., a “floppy disk”) and an optical disk drive for reading or writing from a removable, non-volatile optical disk may be provided. In these cases, each drive may be connected to a bus (not shown) by one or more data media interfaces. The memory 1120 may include a computer program product 1125 having one or more program modules configured to perform various methods or actions of various embodiments of the present disclosure.

The communication unit 1140 implements communication with another electronic device through a communication medium. Additionally, the function of components of the electronic device 1100 may be implemented in a single computing cluster or multiple computing machines capable of communicating over a communication connection. Thus, the electronic device 1100 may operate in a networked environment using logical connections with one or more other servers, network personal computers (PCs), or another network node.

The input device 1150 may be one or more input devices, such as a mouse, a keyboard, a trackball, or the like. The output device 1160 may be one or more output devices, such as a display, a speaker, a printer, or the like. The electronic device 1100 may also communicate with one or more external devices (not shown) through the communication unit 1140 as needed, external devices such as storage devices, display devices, etc., communicate with one or more devices that enable a user to interact with the electronic device 1100, or communicate with any device (e.g., a network card, a modem, etc.) that enables the electronic device 1100 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other device, such that a series of operational steps are performed on a computer, other programmable data processing apparatus, or other device to produce a computer-implemented process such that the instructions executed on a computer, other programmable data processing apparatus, or other device implement the functions/acts specified in the flowchart and/or one or more blocks in the block diagrams.

The flowchart and block diagrams in the figures show architecture, function, and operation possible implemented of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the function involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are illustrative, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method for managing applications, comprising:
receiving a first chat message from a user, the first chat message indicating creation or modification of an application;
determining, based on at least interaction information between the user and a digital assistant, an operation for at least one functional block of the application; and
performing, in response to a reception of a confirmation of the user for the operation in the chat window, the operation on the at least one functional block.

2. The method of claim 1, wherein the interaction information comprises at least:
a reply message of the digital assistant presented in the chat window to the first chat message, the reply message comprising a description of at least one candidate functional block of the application; and
a second chat message from the user received in the chat window.

3. The method of claim 2, wherein the second chat message indicates:
adjustment to the at least one candidate functional block,
confirmation of the reply message, or
negation of the reply message.

4. The method of claim 3, wherein the adjustment to the at least one candidate functional block comprises at least one of:
addition of a functional block different from the at least one candidate functional block,
deletion of a functional block in the at least one candidate functional block, or
modification of a functional block in the at least one candidate functional block.

5. The method of claim 2, wherein the reply message comprises at least one of:
a text message comprising the description, or
a preview of the at least one candidate functional block.

6. The method of claim 1, wherein determining the operation comprises:
generating a first prompt input for a model based on at least the interaction information;
providing the first prompt input to the model; and
obtaining an indication regarding the operation from the model.

7. The method of claim 6, wherein the first prompt input is generated further based on respective description information of a plurality of functional blocks, the description information of each functional block comprising at least a semantic description regarding a function of the functional block.

8. The method of claim 1, further comprising:
presenting, in the chat window, a preview of at least a portion of the application having the at least one functional block.

9. The method of claim 1, further comprising:
presenting an interface for editing the created application; and
adjusting at least a portion of the application, in response to a reception of an adjustment request for the at least a portion of the application in the interface.

10. The method of claim 9, wherein presenting the interface is responsive to at least one of:
a trigger operation from the user to switch to the interface;
completion of the operation; or
the interaction between the user and the digital assistant in the chat window meeting a preset condition.

11. The method of claim 9, further comprising:
presenting the chat window in place of the interface in response to receiving a user input to abandon the created application.

12. The method of claim 9, further comprising:
presenting an interface for providing the adjustment request at a location of the interface associated with the at least a portion; and
receiving the adjustment request via the interface.

13. The method of claim 9, wherein adjusting the at least a portion comprises:
generating a second prompt input for the model based on the adjustment request and information related to the application;
providing the second prompt input to the model;
obtaining an indication regarding an adjustment operation from the model; and
performing the adjustment operation on the at least a portion.

14. The method of claim 1, wherein receiving the first chat message comprises:
presenting an input box and information prompting the user to create or modify an application; and
receiving the first chat message via the input box.

15. The method of claim 1, wherein the first chat message indicates creation of the application, and performing the operation on the at least one functional block comprises:
combining the at least one functional block to create the application.

16. The method of claim 1, wherein the first chat message indicates modification of the application, and performing the operation on the at least one functional block comprises at least one of:
removing a functional block of the at least one functional block from the application,
adding a functional block of the at least one functional block to the application, or
updating a functional block of the at least one functional block already existing in the application.

17. The method of claim 1, wherein the digital assistant is provided by an application platform-as-a-service (aPaaS) based platform.

18. A method for managing applications, comprising:
presenting a first interface associated with one of a first mode and a second mode for application management; and
presenting a second interface associated with the other of the first mode and the second mode in response to a mode switch indication, and
wherein in the first mode, an application management operation is performed by an interaction between a user and a digital assistant in a chat window without an application editing interface, and in the second mode, an application management operation is performed by a user interaction in an application editing interface.

19. The method of claim 18, wherein the first interface is associated with the first mode, and the mode switch indication comprises:
a trigger operation from the user to switch to the second mode,
completion of an operation for at least one functional block of an application, or
the interaction between the user and the digital assistant in the chat window meeting a preset condition.

20-32. (canceled)

33. An electronic device, comprising:
at least one processor; and
at least one memory coupled to the at least one processor and storing instructions for execution by the at least one processor the instructions, when executed by the at least one processor, causing the electronic device to perform acts comprising:
receiving a first chat message from a user, the first chat message indicating creation or modification of an application;
determining, based on at least interaction information between the user and a digital assistant, an operation for at least one functional block of the application; and
performing, in response to a reception of a confirmation of the user for the operation in the chat window, the operation on the at least one functional block.

34. (canceled)
